(19) United States
(12) Patent Application Publication
(10) Pub. No.: US 2022/0084441 A1
(43) Pub. Date: Mar. 17, 2022

(54) HOOK ACCESSORY AND PRESENTATION DEVICE

(71) Applicant: Hanshow Technology Co., Ltd., Jiaxing, Zhejiang (CN)

(72) Inventors: Shiguo HOU, Jiaxing, Zhejiang (CN); Min LIANG, Jiaxing, Zhejiang (CN); Hongbo SHEN, Jiaxing, Zhejiang (CN); Jianguo ZHAO, Jiaxing, Zhejiang (CN); Zhenjie YANG, Jiaxing, Zhejiang (CN)

(21) Appl. No.: 17/432,772

(22) PCT Filed: Feb. 21, 2019
(86) PCT No.: PCT/CN2019/075653

§ 371 Date: Aug. 20, 2021

(51) Int. Cl. G09F 1/10; G09F 7/22

(52) U.S. Cl. CPC G09F 1/10; G09F 7/22

(57) ABSTRACT

The present disclosure provides a hook accessory and a presentation device, relating to a field of daily necessities. The hook accessory comprises: a first accessory provided with an engaging portion, the engaging portion being an unclosed annular structure with an outer surface thereof provided with a protruding portion; a second accessory, comprising: a plug which is an unclosed annular structure, an inner side of the plug being provided with a plurality of grooves in cooperation with the protruding portion and arranged along a circumferential direction of the plug; and a clamping portion for fixing a price tag and in connection with the plug, wherein when the first accessory and the second accessory are rotated relative to each other, the protruding portion is movable along the circumferential direction on the inner side of the plug, so as to cooperate with the plurality of grooves respectively.

### CROSS-REFERENCE TO RELATED APPLICATIONS

This application is a National Stage of International Application No. PCT/CN2019/075653, filed on Feb. 21, 2019. The contents of International Application No. PCT/CN2019/075653 are hereby incorporated by reference herein.

### TECHNICAL FIELD

The present disclosure relates to a field of daily necessities, and particularly to a hook accessory and a presentation device.

### BACKGROUND

In supermarkets and shopping malls, a price tag is usually mounted on a hook to present relevant information of a commodity. In the prior art, a representation angle of the price tag is simplex, and the angle cannot be adjusted when the commodity is viewed at different heights, so that the viewing effect is not good.

Therefore, it is necessary to provide a hook accessory and a presentation device which can solve the above problem.

### SUMMARY

In order to achieve the above objective, the present disclosure provides a hook accessory and a presentation device with simple structures and low use costs, which can facilitate the adjustment of an angle of a price tag while ensuring the price tag to be fixed, so that the price tag can be represented from a plurality of angles. The technical solutions provided by the present disclosure are as follows:

A hook accessory, comprising: a first accessory provided with an engaging portion, the engaging portion being an unclosed annular structure provided with a protruding portion at an outer surface thereof; and a second accessory, comprising: a plug which is an unclosed annular structure, an inner side of the plug being provided with a plurality of grooves in cooperation with the protruding portion and arranged along a circumferential direction of the plug; and a clamping portion for fixing a price tag and in connection with the plug; when the first accessory and the second accessory are rotated relative to each other, the protruding portion is movable along the circumferential direction on the inner side of the plug, so as to cooperate with the plurality of grooves respectively.

As a preferred embodiment, the first accessory further comprises a first extension portion and a second extension portion which are located on two sides of the engaging portion respectively; the first extension portion is provided with a first opening, and the second extension portion is provided with a second opening; when the first accessory and the second accessory are rotated relative to each other, the plug can pass through the first opening and the second opening in turn.

As a preferred embodiment, the first opening and the second opening each has two jacks; the plug comprises a first plug and a second plug, which can pass through the two jacks respectively.

As a preferred embodiment, the protruding portion comprises a boss and a limiting block; when the first accessory and the second accessory are rotated relative to each other, the plug abuts against the limiting block, and the boss is engaged with the plurality of grooves respectively.

As a preferred embodiment, the boss has chamfers or rounded corners, and a predetermined interval is provided between the adjacent grooves.

As a preferred embodiment, the protruding portion is disposed on one side of the engaging portion.

As a preferred embodiment, the clamping portion has a first end and a second end opposite to each other along a length direction thereof; the first end is provided with a first limiting step, and the second end is provided with a second limiting step.

As a preferred embodiment, a clamping plate is disposed on the first limiting step, and a gap is formed between the clamping plate and the plug.

A presentation device, comprising the hook accessory aforementioned, and further comprising a hook provided with a hanging portion and a connecting portion.

As a preferred embodiment, the first accessory further comprises a first extension portion and a second extension portion, which are located on two sides of the engaging portion respectively; a predetermined included angle is formed between the first extension portion and the engaging portion, the engaging portion is engaged into the hanging portion at the predetermined included angle, and the second extension portion is provided with an arc-shaped groove in cooperation with the connecting portion.

According to the hook accessory and the presentation device provided by the embodiments of the present disclosure, the hook accessory has a first accessory and a second accessory. The first accessory is provided with an engaging portion of an annular structure, and an outer surface of the engaging portion is provided with a protruding portion; the second accessory is provided with a plug of an annular structure and a clamping portion, a plurality of grooves are arranged on an inner surface of the plug along a circumferential direction thereof, and the clamping portion is used to fix articles such as a price tag.

During use, the engaging portion of the first accessory is engaged with the plug of the second accessory, and when the first accessory and the second accessory are rotated relative to each other, the protruding portion is movable along the circumferential direction of the plug, so as to cooperate with the plurality of grooves on the inner side of the plug respectively, thereby fixing the angle after rotation.

### BRIEF DESCRIPTION OF DRAWINGS

FIG. 1 is a schematic diagram of a hook accessory in working in an embodiment of the present disclosure;

FIG. 2 is a structural diagram of a first accessory in an embodiment of the present disclosure; and

FIG. 3 is a structural diagram of a second accessory in an embodiment of the present disclosure.

### REFERENCE NUMERALS

1. hook; 11. hanging portion; 12. connecting portion; 2. first accessory; 20. engaging portion; 21. protruding portion; 211. limiting block; 212. boss; 22. first extension portion; 23. second extension portion; 231. arc-shaped groove; 3. second accessory; 31. plug; 311. groove; 32. clamping portion; 321. first limiting step; 322. second limiting step; 33. clamping plate.

### DESCRIPTION OF EMBODIMENTS

The technical solutions of the present disclosure will be described in detail below with reference to the drawings and the specific embodiments. It should be understood that those embodiments are only used to illustrate the present disclosure, rather than limiting a scope. Modifications of various equivalent forms made to the present disclosure by persons skilled in the art after reading the present disclosure should fall within a scope defined by the appended claims of the present disclosure.

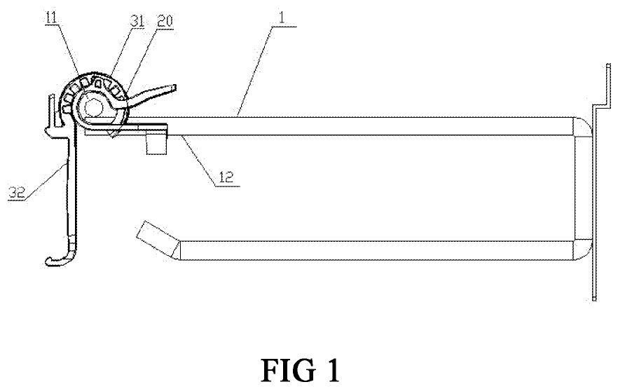

An embodiment of the present disclosure provides a hook accessory, as illustrated in FIGS. 1 to 3, comprising: a first accessory 2 provided with an engaging portion 20, the engaging portion 20 being an unclosed annular structure provided with a protruding portion 21 at an outer surface thereof; a second accessory 3, comprising: a plug 31 which is an unclosed annular structure, an inner side of the plug 31 being provided with a plurality of grooves 311 in cooperation with the protruding portion 21 and arranged along a circumferential direction of the plug 31; and a clamping portion 32 for fixing a price tag and in connection with the plug 31, when the first accessory 2 and the second accessory 3 are rotated relative to each other, the protruding portion 21 is movable along the circumferential direction on the inner side of the plug 31, so as to cooperate with the plurality of grooves 311 respectively.

According to the hook accessory and the presentation device provided by the embodiments of the present disclosure, the hook accessory has a first accessory 2 and a second accessory 3. The first accessory 2 is provided with an engaging portion 20 of an annular structure, and an outer surface of the engaging portion 20 is provided with a protruding portion 21; the second accessory 3 is provided with a plug 31 of an annular structure and a clamping portion 32, a plurality of grooves 311 are arranged on an inner surface of the plug 31 along a circumferential direction thereof, and the clamping portion 32 is used to fix articles such as a price tag.

During use, the engaging portion 20 of the first accessory 2 is engaged with the plug 31 of the second accessory 3, and when the first accessory 2 and the second accessory 3 are rotated relative to each other, the protruding portion 21 is movable along the circumferential direction of the plug 31, so as to cooperate with the plurality of grooves 311 on the inner side of the plug 31 respectively, thereby fixing the angle after rotation.

The first accessory 2 and the second accessory 3 are used to fix an article such as a price tag on the hook 1. In the present disclosure, the application of the hook accessory is described in detail by taking a specific scenario of the hook as illustrated in FIG. 1 as an example. It should be noted that the hook accessory provided by the present disclosure is not limited to the use in this scenario. The hook 1 comprises a hanging portion 11 and a connecting portion 12, which are generally cylindrical structures, the connecting portion 12 is used to support the hanging portion 11, and the price tag is generally fixed on the hanging portion 11.

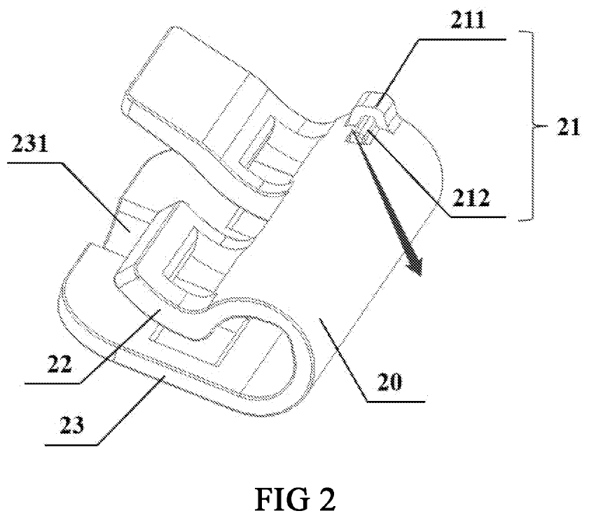

Specifically, referring to FIGS. 1 and 2, the first accessory 2 is provided with an engaging portion 20 used to be engaged with the hanging portion 11 of the hook 1, thereby fixing the first accessory 2 on the hook 1. The engaging portion 20 is specifically an unclosed annular structure with a certain length, which may be equal to a length of the hanging portion 11, and of course, the length of the annular structure may also be larger or smaller than that of the hanging portion 11. A diameter of the engaging portion 20 is not smaller than that of the hanging portion 11, so that the engaging portion 20 can be engaged into the hanging portion 11. The engaging portion 20 has an inner surface and an outer surface opposite to each other, the inner surface is in contact with the hanging portion 11 of the hook 1, and the outer surface is provided with the protruding portion 21.

The engaging portion 20 is extended towards two sides thereof to form an extension portion, and when the engaging portion 20 is engaged with the hanging portion 11, the extension direction of the engaging portion is along the direction of the connecting portion 12. The extension portion comprises a first extension portion 22 and a second extension portion 23 which are located on the two sides of the engaging portion 20 respectively. The first extension portion 22 and the second extension portion 23 are located on upper and lower sides of the hanging portion 11 respectively when the engaging portion 20 is engaged into the hanging portion 11. Further, the extension portions are provided with openings, comprising a first opening located on the first extension portion 22 and a second opening located on the second extension portion 23. The first opening and the second opening are disposed in a rotation path of the plug 31 provided on the second accessory 3, so that the plug can pass through the first opening and the second opening in turn when the first accessory 2 and the second accessory 3 are rotated relative to each other.

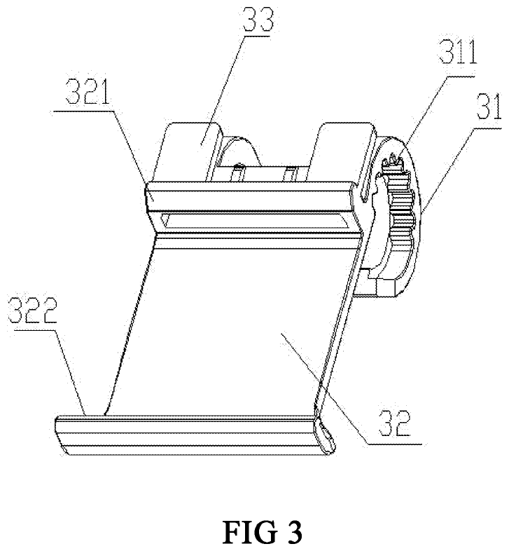

Referring to FIGS. 1 and 3, the plug 31 can be engaged with the engaging portion 20 on the first accessory 2. The plug 31 is specifically an unclosed annular structure with a diameter slightly larger than that of the engaging portion 20, so that the plug 31 can be engaged into the engaging portion 20. The plug 31 has an inner surface and an outer surface opposite to each other, and the inner surface is provided with a groove 311 in cooperation with the protruding portion 21, when the protruding portion 21 is in cooperation with the groove 311, the plug 31 can be fixed with the engaging portion 20. In this embodiment, there are a plurality of grooves 311 arranged in a circumferential direction of the plug 31.

When the first accessory 2 and the second accessory 3 are rotated relative to each other, the protruding portion 21 on the engaging portion 20 is engaged with the plurality of grooves 311 respectively. Due to the cooperation between the protruding portion 21 and the groove 311, the plug 31 and the engaging portion 20 can be fixed relative to each other when a relative rotation between the first accessory 2 and the second accessory 3 stops. In addition, the plug 31 can pass through the first opening on the first extension portion 22 and the second opening on the second extension portion 23 in turn during rotation, thereby further fixing the first accessory 2 and the second accessory 3 on the hook 1.

Further, the first opening and the second opening each has two jacks which are located on two sides of the connecting portion 12. Correspondingly, the plug 31 comprises a first plug and a second plug, which can pass through the two jacks respectively and disposed on the two sides of the connecting portion 12. The first plug and/or the second plug is internally provided with the grooves 311. When the first plug and the second plug are both internally provided with the structure of the grooves 311, there may be two corresponding protruding portions 21 disposed on the outer surface of the engaging portion 20.

In an embodiment, as illustrated in FIGS. 1 and 2, the protruding portion 21 comprises a boss 212 and a limiting block 211; when the first accessory 2 and the second accessory 3 are rotated relative to each other, the plug 31 abuts against the limiting block 211, and the boss 212 is engaged with the plurality of grooves 311 respectively.

Specifically, the boss 212 is used to be engaged with the groove 311, and may have chamfers or rounded corners to reduce a friction resistance of the boss 212 during its rotation in the groove 311. One side of the boss 212 is provided with the limiting block 211 with a height larger than a depth of the groove 311, and the limiting block 211 can abut against an outer side of the groove 311 to axially limit the plug 31. When the first accessory 2 and the second accessory 3 are rotated relative to each other, the plug 31 abuts against the limiting block 211, and at the same time, the grooves 311 on the inner side of the plug 31 can be engaged with the boss 212 respectively, so that the angle can be adjusted and fixed.

Further, a predetermined interval is provided between the adjacent grooves 311, and in principle, the predetermined interval should be as small as possible, when a distance between the adjacent grooves 311 is small, the rotation of the plug 31 will be smooth. Meanwhile, due to the cooperation between the boss 212 and the groove 311, the rotation angle can be fixed. Therefore, when the predetermined interval between the adjacent grooves 311 is small, during each rotation, the rotation is smooth and the angle can be fixed quickly, so the experience is better.

In one embodiment, the protruding portion 21 is disposed on one side of the engaging portion 20. Preferably, the protruding portion 21 is disposed on an outermost side of the engaging portion 20, so that when the first accessory 2 and the second accessory 3 are rotated relative to each other, a user can clearly observe the cooperation state between the protruding portion 21 and the groove 311, which facilitates the adjustment of the required angle.

As illustrated in FIG. 3, the second accessory 3 further comprises a clamping portion 32 for fixing a price tag. The clamping portion 32 is connected to the plug 31, and the specific connection mode may be welding or integrated molding. The clamping portion 32 specifically may be a plate structure with a certain length and width. The plate structure has a first end and a second end opposite to each other along a length direction thereof. The first end is provided with a first limiting step 321 and the second end is provided with a second limiting step 322, and the price tag may be engaged between the first limiting step 321 and the second limiting step 322.

When the price tag is fixed to the clamping portion 32, if it is necessary to adjust the angle to check commodity information, the clamping portion 32 may be rotated to drive the plug 31 to rotate. By the cooperation between the groove 311 in the first plug and/or the second plug and the protruding portion 21 on the engaging portion 20, the rotation angle can be adjusted and fixed, thus meeting the demand of representing the price tag at different angles. Specifically, when the price tag is located at a higher position, the clamping portion 32 may be rotated counterclockwise until the commodity information on the price tag is within a visual field, and the price tag is fixed at a desired angle by the cooperation between the groove 311 and the boss 212; when the price tag is located at a lower position, the clamping portion 32 may be rotated clockwise until the commodity information on the price tag is within the visual field, and the price tag is fixed at a desired angle by the cooperation between the groove 311 and the boss 212.

In one embodiment, the first limiting step 321 is further provided with a clamping plate 33, with a gap formed between the clamping plate 33 and the plug 31. The shape of the clamping plate 33 is not specifically limited, and it may be a plate or composed of a plurality of elastic walls. There is a certain gap between the clamping plate 33 and the plug 31, so as to clamp a sales-promotion tag.

The present disclosure further provides a presentation device as illustrated in FIG. 1, which comprises the hook accessory and the hook 1, and the hook 1 is provided with the hanging portion 11 and the connecting portion 12.

In one embodiment, the engaging portion 20 forms a predetermined included angle with the first extension portion 22, so that the engaging portion 20 is engaged into the hanging portion 11 at the predetermined included angle, and the second extension portion 23 is provided with an arc-shaped groove 231 in cooperation with the connecting portion 12.

Specifically, a predetermined included angle may be formed between the first extension portion 22 and the engaging portion 20, so that the first extension portion 22 has a certain inclined angle with respect to a horizontal direction, and the engaging portion 20 can be engaged into the hanging portion 11 at the predetermined included angle. In addition, when the plug 31 is rotated relative to the engaging portion 20, the engaging portion 20 is stable and will not move with the rotation of the plug 31 due to the predetermined included angle. The second extension portion 23 is provided with the arc-shaped groove 231, so that when the first accessory 2 is engaged with the hanging portion 11, the arc-shaped groove 231 can be engaged with the connecting portion 12, thereby limiting the position of the first accessory 2 on the hook 1 and ensuring the stability of the first accessory 2 during use.

In view of the above description, the hook accessory and the presentation device provided by the present disclosure have the following advantages: the hook accessory is used to fix the price tag on the hook, and the rotation angle of the price tag can be adjusted and fixed by rotating the second accessory, so that the price tag can be represented from a plurality of angles to meet the demands of different sight heights. The hook accessory and the presentation device provided by the present disclosure are very stable during use with simple structures, convenient operations, and low use costs, and then can be widely applied.

It should be understood that the above description is only for illustrations rather than limitations. Many embodiments and applications besides the examples provided will be apparent to persons skilled in the art by reading the above description. Thus, the scope of the teachings should not be determined with reference to the above description, but determined with reference to the appended claims and a full range of equivalents owned by the claims. For a comprehensive purpose, all articles and references, including disclosures of patent applications and publications, are incorporated herein by reference. The omission of any aspect of the subject matter disclosed here in the claims is neither intended to give up the content of the subject matter, nor should it be considered that the applicant has not considered the subject matter as a part of the disclosed subject matter.

1. A hook accessory, wherein, the hook accessory comprising:
a first accessory provided with an engaging portion, the engaging portion being an unclosed annular structure provided with a protruding portion at an outer surface thereof; and
a second accessory, comprising:
a plug which is an unclosed annular structure, an inner side of the plug being provided with a plurality of grooves in cooperation with the protruding portion and arranged along a circumferential direction of the plug; and
a clamping portion for fixing a price tag and in connection with the plug;
when the first accessory and the second accessory are rotated relative to each other, the protruding portion is movable along the circumferential direction on the inner side of the plug, so as to cooperate with the plurality of grooves respectively.

2. The hook accessory according to claim 1, wherein, the first accessory further comprises a first extension portion and a second extension portion which are located on two sides of the engaging portion respectively;
the first extension portion is provided with a first opening, and the second extension portion is provided with a second opening;
when the first accessory and the second accessory are rotated relative to each other, the plug can pass through the first opening and the second opening in turn.

3. The hook accessory according to claim 2, wherein, the first opening and the second opening each has two jacks; the plug comprises a first plug and a second plug, which can pass through the two jacks respectively.

4. The hook accessory according to claim 1, wherein, the protruding portion comprises a boss and a limiting block; when the first accessory and the second accessory are rotated relative to each other, the plug abuts against the limiting block, and the boss is engaged with the plurality of grooves respectively.

5. The hook accessory according to claim 4, wherein, the boss has chamfers or rounded corners, and a predetermined interval is provided between the adjacent grooves.

6. The hook accessory according to claim 5, wherein, the protruding portion is disposed on one side of the engaging portion.

7. The hook accessory according to claim 1, wherein, the clamping portion has a first end and a second end opposite to each other along a length direction thereof; the first end is provided with a first limiting step, and the second end is provided with a second limiting step.

8. The hook accessory according to claim 7, wherein, a clamping plate is disposed on the first limiting step, and a gap is formed between the clamping plate and the plug.

9. A presentation device, wherein, the presentation device comprising the hook accessory according to claim 1, and further comprising a hook provided with a hanging portion and a connecting portion.

10. The presentation device according to claim 9, wherein, the first accessory further comprises a first extension portion and a second extension portion, which are located on two sides of the engaging portion respectively;
a predetermined included angle is formed between the first extension portion and the engaging portion, the engaging portion is engaged into the hanging portion at the predetermined included angle, and the second extension portion is provided with an arc-shaped groove in cooperation with the connecting portion.
